(19) United States
(12) Patent Application Publication
(10) Pub. No.: US 2026/0307543 A1
(43) Pub. Date: Oct. 8, 2026

(54) VEHICLE SEAT AND MANUFACTURING METHOD OF VEHICLE SEAT

(71) Applicants: TS TECH CO., LTD., Asaka-shi, Saitama (JP); ALPS ALPINE CO., LTD., Ota-ku, Tokyo (JP)

(72) Inventors: Kazumasa NARITA, Tochigi (JP); Yutaro ISHIZAWA, Miyagi (JP); Masashi TABATA, Miyagi (JP); Takahiro KAWAUCHI, Miyagi (JP)

(21) Appl. No.: 19/485,068

(22) PCT Filed: May 21, 2024
(86) PCT No.: PCT/JP2024/018680

§ 371 Date: Nov. 17, 2025

Related U.S. Application Data
(60) Provisional application No. 63/503,581, filed on May 22, 2023.

(51) Int. Cl. B60N 2/00

(52) U.S. Cl. CPC B60N 2/0022; B60N 2/0034; B60N 2210/12

(57) ABSTRACT

A vehicle seat-includes a pad member, a sheet-shaped member covering a surface of the pad member, a back member provided on a back surface side of the sheet-shaped member, and a sensor including a detecting unit configured to acquire information related to a seated person, and at least a portion of the detecting unit is arranged between the sheet-shaped member and the back member.

### CROSS-REFERENCE TO RELATED APPLICATIONS

This application is the U.S. National Stage entry of International Application No. PCT/JP2024/018680, filed on May 21, 2024, which, in turn, claims priority to U.S. Provisional Patent Application No. 63/503,581, filed on May 22, 2023, both of which are hereby incorporated herein by reference in their entireties for all purposes.

### TECHNICAL FIELD

The present invention relates to a vehicle seat and a manufacturing method of the vehicle seat.

### BACKGROUND ART

Patent Document 1 discloses a vehicle seat provided with a biometric sensor in a seat back for detecting biometric information about an occupant. The vehicle seat in Patent Document 1 includes a back pad that constitutes the seat back, and a seat skin that covers the back pad. The seat skin comprises a skin material and a laminated pad provided on a back surface of the skin material, and the biometric sensor is fixed to a back surface of the laminated pad.

### PRIOR ART DOCUMENT(S)

### Patent Document(s)

Patent Document 1: JP2014-231254A

### SUMMARY OF THE INVENTION

### Task to be Accomplished by the Invention

To improve the comfort and safety of vehicles, there is a demand to develop the vehicle seat that can more accurately detect presence or absence of a seated person and information related to the seated person.

In view of the above background, an object of the present invention is to improve detection accuracy of a sensor in the vehicle seat provided with the sensor that detects information related to the seated person.

### Means to Accomplish the Task

To achieve such an object, one aspect of the present invention provides a vehicle seat (1) including: a pad member (11); a sheet-shaped member (22) covering a surface of the pad member; a back member (21) provided on a back surface side of the sheet-shaped member; and a sensor (23) including a detecting unit (30) configured to acquire information related to a seated person, and at least a portion of the detecting unit is arranged between the sheet-shaped member and the back member.

According to this aspect, only the sheet-shaped member is provided between the detecting unit and the seated person. Accordingly, it is possible to improve detection accuracy of the sensor compared to when two members, the sheet-shaped member and the back member, are provided between the detecting unit and the seated person.

In the above aspect, preferably, the sheet-shaped member and the back member constitute a skin material (12), and the back member includes an adhered portion (25) adhered to the sheet-shaped member and a non-adhered portion (26) that cooperates with the sheet-shaped member to define an accommodating space (28) for accommodating the detecting unit.

According to this aspect, it is possible to arrange the detecting unit between the sheet-shaped member and the back member.

In the above aspect, preferably, the back member is formed in a sheet shape extending along the surface of the pad member and provided with a slit (27) extending along the non-adhered portion.

According to this aspect, it is possible to easily arrange the detecting unit between the sheet-shaped member and the back member.

In the above aspect, preferably, the back member is provided with a slit (27) connected to the accommodating space.

According to this aspect, it is possible to easily arrange the detecting unit between the sheet-shaped member and the back member.

In the above aspect, preferably, the back member is more flexible than the sheet-shaped member.

According to this aspect, it is possible to reduce foreign body sensation that may be caused to the seated person by providing the sensor.

In the above aspect, preferably, the detecting unit is provided with an electrode (30A) for detecting the seated person based on a change in capacitance.

According to this aspect, since the electrode can be arranged in a position closer to the seated person, it is possible to reliably detect the presence or absence of the seated person.

In the above aspect, preferably, the detecting unit is provided with an electrode (30A) that is electrostatically coupled to a body of the seated person to detect an electrical potential of a body surface of the seated person so as to acquire at least one of heart rate, heartbeat interval, and an electrocardiogram of the seated person.

According to this aspect, since the electrode can be arranged in a position closer to the seated person, it is possible to reliably detect at least one of the heart rate, the heartbeat interval, and the electrocardiogram of the seated person.

In the above aspect, preferably, the sensor includes a harness connected to the detecting unit, and the pad member is provided with a through hole (32) through which the harness passes.

According to this aspect, it is possible to easily route the harness.

To achieve such an object, one aspect of the present invention provides a manufacturing method of a vehicle seat (1), the vehicle seat including: a pad member (11); a sheet-shaped member (22) covering a surface of the pad member; a back member (21) provided on a back surface side of the sheet-shaped member, and a sensor (23) including a detecting unit (30) configured to acquire information related to a seated person, and the method including steps of: peeling at least a portion of the back member from the sheet-shaped member; and sandwiching the detecting unit between the sheet-shaped member and the back member peeled from the sheet-shaped member.

According to this aspect, the manufacturing method of the vehicle seat is provided in which only the sheet-shaped member is provided between the detecting unit and the seated person. Accordingly, it is possible to provide the manufacturing method of the vehicle seat in which the detection accuracy of the sensor can be improved compared to when two members, the sheet-shaped member and the back member, are provided between the detecting unit and the seated person.

In the above aspect, preferably, the back member is provided with a slit (27) extending along a portion to be peeled.

According to this aspect, it is possible to easily peel the back member from the sheet-shaped member.

In the above aspect, preferably, the manufacturing method of the vehicle seat includes steps of: providing a masking material (34) on a back surface of the sheet-shaped member in a portion corresponding to the back member to be peeled; and applying adhesive to the back surface of the sheet-shaped member.

According to this aspect, it is possible to easily sandwich the detecting unit between the sheet-shaped member and the back member.

### Effect of the Invention

One aspect of the present invention provides a vehicle seat (1) including: a pad member (11); a sheet-shaped member (22) covering a surface of the pad member; a back member (21) provided on a back surface side of the sheet-shaped member; and a sensor (23) including a detecting unit (30) configured to acquire information related to a seated person, and at least a portion of the detecting unit is arranged between the sheet-shaped member and the back member.

According to this aspect, only the sheet-shaped member is provided between the detecting unit and the seated person. Accordingly, it is possible to improve detection accuracy of the sensor compared to when two members, the sheet-shaped member and the back member, are provided between the detecting unit and the seated person.

In the above aspect, preferably, the sheet-shaped member and the back member constitute a skin material (12), and the back member includes an adhered portion (25) adhered to the sheet-shaped member and a non-adhered portion (26) that cooperates with the sheet-shaped member to define an accommodating space (28) for accommodating the detecting unit.

According to this aspect, it is possible to arrange the detecting unit between the sheet-shaped member and the back member.

In the above aspect, preferably, the back member is formed in a sheet shape extending along the surface of the pad member and provided with a slit (27) extending along the non-adhered portion.

According to this aspect, it is possible to easily arrange the detecting unit between the sheet-shaped member and the back member.

In the above aspect, preferably, the back member is provided with a slit (27) connected to the accommodating space.

According to this aspect, it is possible to easily arrange the detecting unit between the sheet-shaped member and the back member.

In the above aspect, preferably, the back member is more flexible than the sheet-shaped member.

According to this aspect, it is possible to reduce foreign body sensation that may be caused to the seated person by providing the sensor.

In the above aspect, preferably, the detecting unit is provided with an electrode (30A) for detecting the seated person based on a change in capacitance.

According to this aspect, since the electrode can be arranged in a position closer to the seated person, it is possible to reliably detect the presence or absence of the seated person.

In the above aspect, preferably, the detecting unit is provided with an electrode (30A) that is electrostatically coupled to a body of the seated person to detect an electrical potential of a body surface of the seated person so as to acquire at least one of heart rate, heartbeat interval, and an electrocardiogram of the seated person.

According to this aspect, since the electrode can be arranged in a position closer to the seated person, it is possible to reliably detect at least one of the heart rate, the heartbeat interval, and the electrocardiogram of the seated person.

In the above aspect, preferably, the sensor includes a harness connected to the detecting unit, and the pad member is provided with a through hole (32) through which the harness passes.

According to this aspect, it is possible to easily route the harness.

One aspect of the present invention provides a manufacturing method of a vehicle seat (1), the vehicle seat including: a pad member (11); a sheet-shaped member (22) covering a surface of the pad member; a back member (21) provided on a back surface side of the sheet-shaped member, and a sensor (23) including a detecting unit (30) configured to acquire information related to a seated person, and the method including steps of: peeling at least a portion of the back member from the sheet-shaped member; and sandwiching the detecting unit between the sheet-shaped member and the back member peeled from the sheet-shaped member.

According to this aspect, the manufacturing method of the vehicle seat is provided in which only the sheet-shaped member is provided between the detecting unit and the seated person. Accordingly, it is possible to provide the manufacturing method of the vehicle seat in which the detection accuracy of the sensor can be improved compared to when two members, the sheet-shaped member and the back member, are provided between the detecting unit and the seated person.

In the above aspect, preferably, the back member is provided with a slit (27) extending along a portion to be peeled.

According to this aspect, it is possible to easily peel the back member from the sheet-shaped member.

In the above aspect, preferably, the manufacturing method of the vehicle seat includes steps of: providing a masking material (34) on a back surface of the sheet-shaped member in a portion corresponding to the back member to be peeled; and applying adhesive to the back surface of the sheet-shaped member.

According to this aspect, it is possible to easily sandwich the detecting unit between the sheet-shaped member and the back member.

### BRIEF DESCRIPTION OF THE DRAWING(S)

FIG. 1 A perspective view of a seat according to a first embodiment of the present invention

FIG. 2 A perspective cross-sectional view of the seat

FIG. 3 (A) A top view of a seat cushion and (B) A front view of a seat back

FIG. 4 (A) An enlarged view of an IVA portion of FIG. 3 and (B) A cross-sectional view taken along a line IVB-IVB of FIG. 4 in (A)

FIG. 5 (A) An explanatory diagram showing a step of peeling a back member, (B) An explanatory diagram for explaining a step of inserting a detecting unit, and (C) A schematic diagram showing an example of an area of the sheet-shaped member to which adhesive is applied, in a manufacturing process of the seat,

FIG. 6 (A) A cross-sectional view of the seat according to first modified embodiment, (B) A cross-sectional view of the seat according to second modified embodiment, and (C) A cross-sectional view of the seat according to a third modified embodiment, of the first embodiment

FIG. 7 A cross-sectional view of the seat according to a second embodiment of the present invention

FIG. 8 (A) A front view and (B) A cross-sectional view, of the sensor provided on the seat according to a third embodiment of the present invention

### MODE(S) FOR CARRYING OUT THE INVENTION

In the following, with reference to the drawings, an embodiment in which a vehicle seat according to the present invention is applied to a seat that constitutes a front passenger seat provided in a first row of an automobile. The vehicle seat according to the present invention may be applied to a seat that constitutes a rear seat provided in a second row or a subsequent row of the automobile.

### First Embodiment

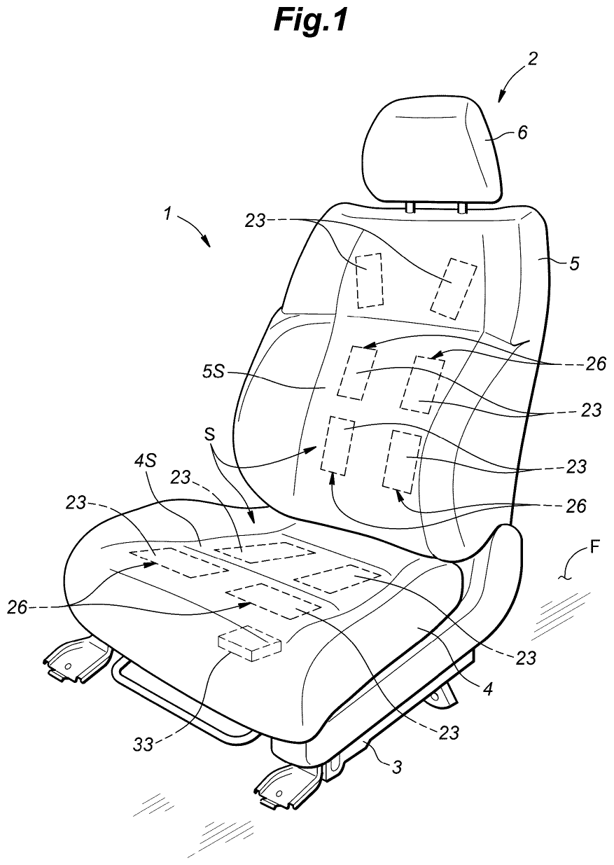

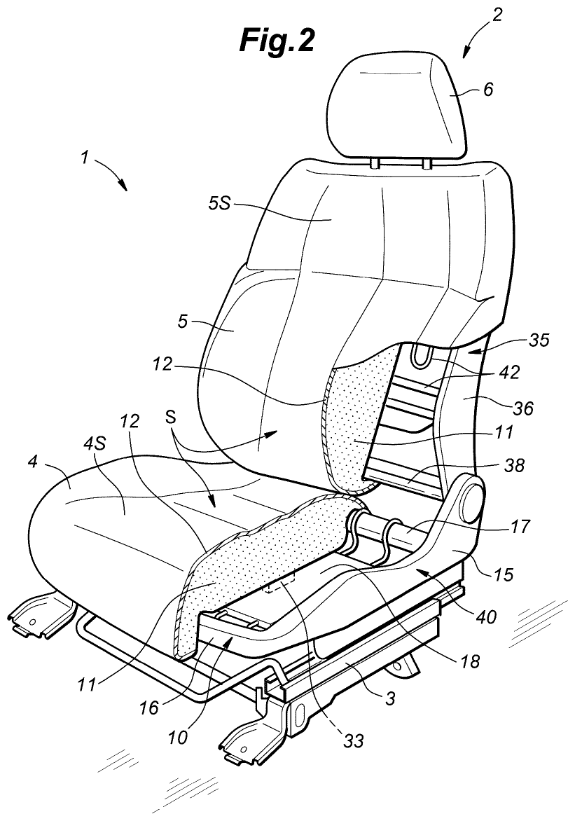

As shown in FIGS. 1 and 2, a seat 1 is arranged on a floor F that defines a vehicle cabin. The seat 1 includes a seat body 2 and a slide device 3 that slidably connects the seat body 2 to the floor F. The seat body 2 may be supported directly on a floor panel that forms the floor F of the automobile, or may be supported by a frame member that is supported by the floor panel.

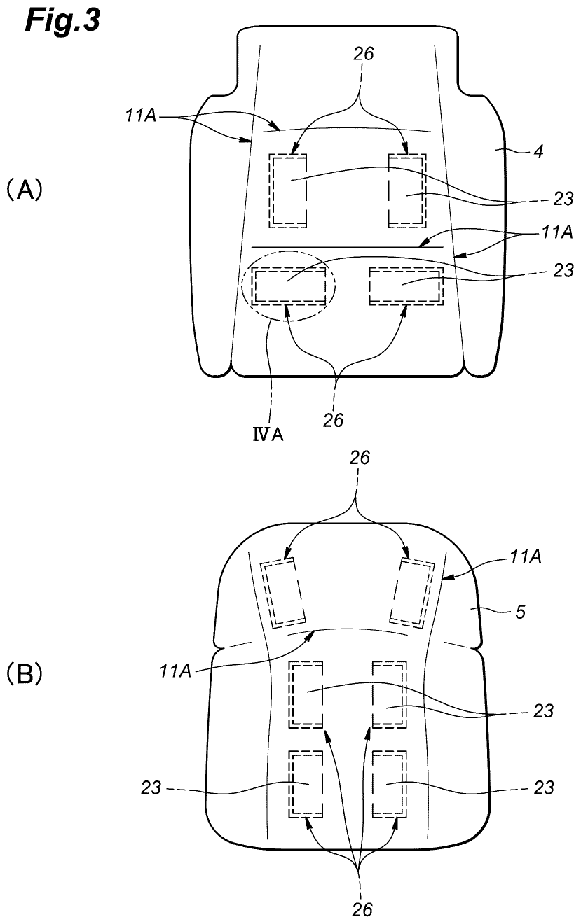

The seat body 2 includes a seat cushion 4, a seat back 5, and a headrest 6. As shown in FIGS. 1 and 3 in (A), the seat cushion 4 includes the seat surface 4S on the upper surface thereof. The seat cushion 4 supports the buttocks of a seated person seated on the seat surface 4S from below. The seat back 5 extends upward from a rear portion of the seat cushion 4. As shown in FIGS. 1 and 3 in (B), the seat back 5 includes, on the front surface thereof, a backrest surface 5S that faces the back of the seated person. The seat back 5 supports the back of the seated person leaning against the backrest surface 5S from behind. The headrest 6 is provided in the upper portion of the seat back 5 and is arranged behind the head of the seated person.

Hereinafter, the seat surface 4S and the backrest surface 5S will be collectively referred to as a seating surface S.

As shown in FIG. 2, the seat cushion 4 is provided with a seat cushion frame 10, a pad member 11 supported by the seat cushion frame 10, and a skin material 12 covering the surface of the pad member 11.

The seat cushion frame 10 is mainly composed of metal members and forms a skeleton of the seat cushion 4. The seat cushion frame 10 includes left and right seat cushion side members 15 extending longitudinally on either side, a front member 16 extending laterally and joined to the front ends of the left and right seat cushion side members 15, and a rear member 17 extending laterally and joined to the rear ends of the left and right seat cushion side members 15, and formed in a rectangular frame shape as seen in top view.

A flexible support frame 18 extends across the seat cushion frame 10 to support the buttocks of the seated person. The support frame 18 extends between the front member 16 and the rear member 17. The support frame 18 may include a plurality of metal wires and a flexible resin plate joined to each wire.

The pad member 11 is formed from a flexible material such as urethane. The pad member 11 has a substantially rectangular parallelepiped shape.

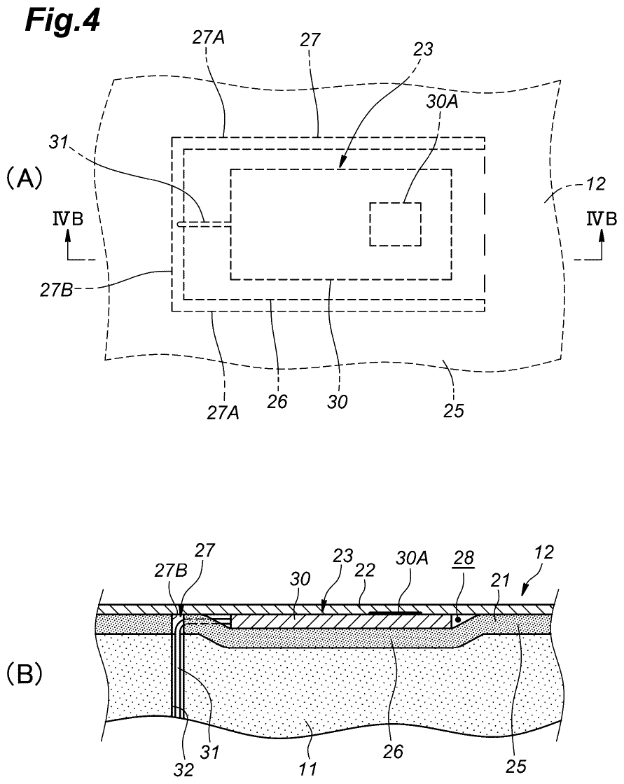

As shown in FIG. 4 in (A) and 4 in (B), the skin material 12 includes a back member 21 that constitutes the pad member 11 side, a sheet-shaped member 22 that constitutes the outer surface of the seat cushion 4, and a sensor 23 that detects information related to the seated person.

The back member 21 is formed in a sheet shape and is arranged along the surface of the pad member 11. The back member 21 is formed from a material that is more flexible than the sheet-shaped member 22. The back member 21 may be formed from, for example, urethane foam or nonwoven fabric. The back member 21 is preferably more flexible than the pad member 11.

The back member 21 includes an adhered portion 25 adhered to the back surface of the sheet-shaped member 22, and a non-adhered portion 26 spaced apart from the sheet-shaped member 22 in the front-to-back direction (i.e., substantially up-and-down direction). In the present embodiment, the non-adhered portion 26 is substantially rectangular with four sides when viewed in the front-to-back direction (also referred to as a plan view or top view), and is surrounded by the adhered portion 25.

As shown in FIG. 4 in (A), the back member 21 is provided with a slit 27 extending along the boundary between the adhered portion 25 and the non-adhered portion 26. The slit 27 is formed by cutting out the back member 21 along the boundary between the adhered portion 25 and the non-adhered portion 26. In the present embodiment, the slit 27 includes a pair of lateral portions 27A that are parallel to each other and extend in the prescribed direction, and a longitudinal portion 27B that extends in a direction perpendicular to the extension direction of the lateral portions 27A and connects the ends of the lateral portions 27A, and formed in a U-shape (also referred to as a C-shape) when viewed in the front-to-back direction. The non-adhered portion 26 is adjacent to the adhered portion 25 via the slit 27 on three sides, and is connected (also referred to as continuous) to the adhered portion 25 on the remaining side.

In the present embodiment, the non-adhered portions 26 are arranged side by side, one on each side, at the rear and center portions of the seat cushion 4. As shown in FIG. 3, the pad member 11 of the seat cushion 4 is provided with a listing groove 11A for pulling in the skin material 12 at an appropriate position. The non-adhered portion 26 is arranged at a position that avoids the listing groove 11A when viewed in the front-to-back direction.

As shown in FIG. 4 in (B), the sheet-shaped member 22 is formed in a sheet shape and is arranged along the surface of the pad member 11. The back member 21 is provided on the back surface side of the sheet-shaped member 22, and the sheet-shaped member 22 is arranged to cover the surface of the pad member 11. The sheet-shaped member 22 is formed from a material that is less flexible than the back member 21. The sheet-shaped member 22 may be, for example, natural leather, synthetic leather, woven fabric, or jersey material. The back surface of the sheet-shaped member 22 is bonded (in the present embodiment, adhered) to the upper surface of the adhered portion 25, and the front surface thereof constitutes the seating surface S (seat surface 4S). An accommodating space 28 for accommodating at least a portion of the sensor 23 is defined between the sheet-shaped member 22 and the non-adhered portion 26 of the back member 21.

The sensor 23 includes a detecting unit 30 for detecting various information including biometric information related to the seated person, and a harness 31 connected to the detecting unit 30. The information detected by the detecting unit 30 may be, for example, the presence or absence of the seated person, temperature, humidity, pressure applied by the seated person, the heart rate, the heartbeat interval, and the electrocardiogram of the seated person. By detecting the body surface potential of the seated person, the heart rate, the heartbeat interval, and the electrocardiogram can be acquired.

As shown in FIG. 4 in (B), the detecting unit 30 is formed in a flat plate shape (seat shape). In the present embodiment, the detecting unit 30 is provided with an electrode 30A whose capacitance changes depending on the proximity and/or presence of the seated person. That is, the sensor 23 is constituted by a capacitive proximity sensor that detects the presence or absence of the seated person by detecting a change in the capacitance of the electrode 30A. However, the present embodiment is not limited to this, and the sensor 23 may also be a temperature sensor that detects the temperature near the detecting unit 30 based on changes in resistance of a resistance temperature detector or thermistor or the like provided in the detecting unit 30. Alternatively, the sensor 23 may be provided in the detecting unit 30 to detect the presence or absence of the seated person, and may be constituted by a switch (membrane switch, and the like) that turns on and off depending on the load applied to the main surface of the detecting unit 30. The detecting unit 30 may also be provided with the electrode 30A that is electrostatically coupled to the body of the seated person to detect an electrical potential of the body surface of the seated person. Since the electrical potential of the body surface changes depending on the heartbeat, the heart rate, the heartbeat interval, and the electrocardiogram of the seated person can be acquired by using the electrical potential detected by the electrode 30A. In addition to the electrode 30A and the harness 31, the sensor 23 may include all or a portion of a processing circuit for acquiring the heart rate, the heartbeat interval, and the electrocardiogram using the electrical potential detected by the electrode 30A. The processing circuit may be provided, for example, between the electrode 30A and the harness 31.

The detecting unit 30 is accommodated in the accommodating space 28 formed between the sheet-shaped member 22 and the non-adhered portion 26 of the back member 21. The slit 27 extends along the boundary of the accommodating space 28 and is connected to the accommodating space 28. The detecting unit 30 is sandwiched between the sheet-shaped member 22 and the back member 21 in the front-to-back direction, and is joined to at least one of the sheet-shaped member 22 and the back member 21. Thus, by providing the non-adhered portion 26 and the adhered portion 25 on the back member 21, the back member 21 can be joined to the sheet-shaped member 22 while the detecting unit 30 is arranged between the sheet-shaped member 22 and the back member 21 and joined to the skin material 12. In the example shown in FIG. 4 in (B), the entire detecting unit 30 is accommodated in the accommodating space 28, but at least a portion of the detecting unit 30 may be accommodated in the accommodating space 28 and sandwiched between the sheet-shaped member 22 and the back member 21 in the front-to-back direction.

The pad member 11 is provided with a through hole 32 through which the harness 31 passes. The through hole 32 passes through the pad member 11 in the front-to-back direction. The harness 31 passes through the through hole 32 and is connected to an electronic control unit (ECU) 33 provided in the seat body 2 or the vehicle body. By providing the through hole 32 in the pad member 11, the harness 31 can be easily routed to the electronic control unit 33. The through hole 32 may be provided inside the listing groove 11A, or may be provided at a position that avoids the listing groove 11A.

As shown in FIG. 2, the seat back 5 includes a seat back frame 35, the pad member 11 supported by the seat back frame 35, and the skin material 12 covering the surface of the pad member 11.

The seat back frame 35, similar to the seat cushion frame 10, is composed of metal members. The seat back frame 35 includes a pair of seat back side members 36 extending vertically on either side, an upper member (not shown) joining the upper ends of the seat back side members 36, and lower member 38 connecting the lower portions of the seat back side members 36, and is formed in a rectangular frame shape when viewed in the front-and-rear direction. The seat back frame 35 is connected at its lower portion to the seat cushion frame 10 so as to be tiltable via a reclining device (not shown).

The seat cushion frame 10 and the seat back frame 35 joined to the seat cushion frame 10 constitute a seat frame 40, which forms the skeleton of the seat body 2.

The seat back frame 35 is provided with a pressure receiving member 42. As shown in FIG. 2, the pressure receiving member 42 includes a wire member that extends between the left and right seat back side members 36. The pressure receiving member 42 deflects under the rearward load applied by the seated person, and supports the seated person from behind.

The pad member 11, similar to the seat cushion 4, is formed from a flexible material such as urethane.

The skin material 12 includes the back member 21, the sheet-shaped member 22, and the sensor 23, and has the same configuration as the skin material 12 provided on the seat cushion 4. As shown in FIG. 3 in (B), the non-adhered portions 26 are arranged in pairs, one on each side, at the upper, center, and lower portions of the seat back 5. As shown in FIG. 3 in (A) and 3 in (B), the pad member 11 of the seat back 5 is provided with the listing groove 11A for pulling in the skin material 12, similar to the seat cushion 4. The non-adhered portion 26 is arranged at a position that avoids the listing groove 11A when viewed in the front-to-back direction (plan view). The detecting unit 30 of the sensor 23 is provided on the back surface side of the non-adhered portion 26.

Next, a manufacturing method of the seat 1 will be described.

An operator manufacturing the seat 1 prepares the seat frame 40 and places the pad member 11 of the seat back 5 and the pad member 11 of the seat cushion 4 in the appropriate positions on the seat frame 40.

Next, the operator prepares a sheet material in which the sheet-shaped member 22 and the back member 21 are adhered together with adhesive, and the sensor 23. The sheet material may be formed of a laminated film in which the back member 21 is adhered to the sheet-shaped member 22 with an adhesive or resin. At this time, the sheet-shaped member 22 constitutes a surface layer of the sheet material, and the back member 21 constitutes a laminated layer (also referred to as a laminated pad) of the sheet material.

The operator prepares the sheet material and the sensor 23 for the seat back 5 and the seat cushion 4. Thereafter, the operator forms the slit 27 in the back member 21 by cutting out the appropriate positions of the back member 21 in a U-shape.

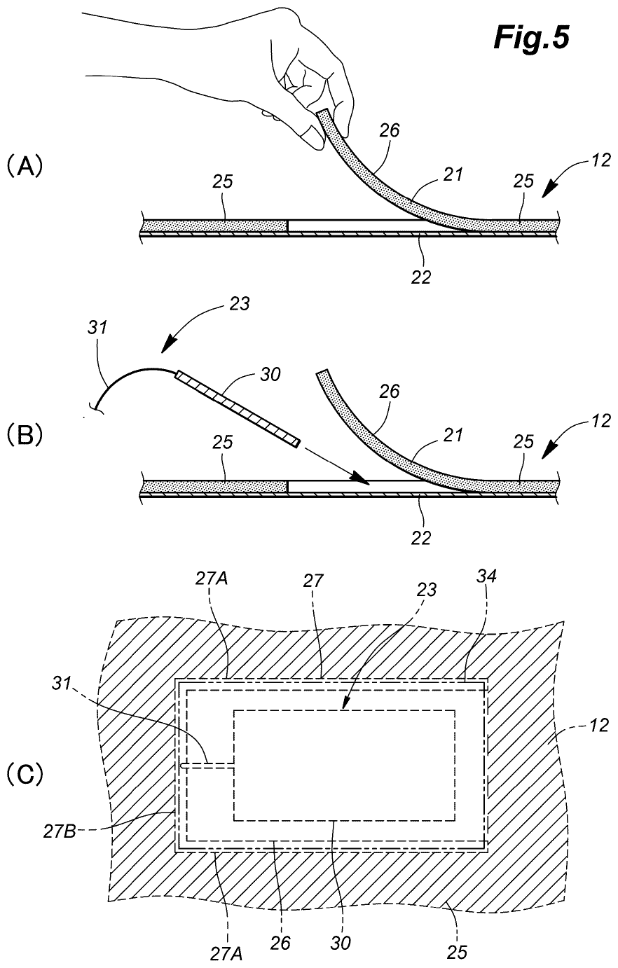

Next, as shown in FIG. 5 in (A), the operator performs a step of peeling the portion of the back member 21 surrounded by the slit 27 from the sheet-shaped member 22. Thereafter, as shown in FIG. 5 in (B), the operator performs the step of sandwiching the detecting unit 30 between the sheet-shaped member 22 and the back member 21. The detecting unit 30 is sandwiched between the sheet-shaped member 22 and the back member 21, and adhered to the sheet-shaped member 22 and the back member 21 by the adhesive provided on the sheet-shaped member 22 and the back member 21. Thus, the skin material 12 for the seat back 5 and the skin material 12 for the seat cushion 4 are manufactured.

Thereafter, the operator passes the harness 31 through the through hole 32, covers the pad member 11 of the seat back 5 with the skin material 12, and further covers the pad member 11 of the seat cushion 4 with the skin material 12. Thereby, the production of the seat 1 is completed.

It is preferable that the adhesive be applied in advance only to the portion of the sheet-shaped member 22 that is in contact with the adhered portion 25, and that the adhesive not be applied in advance to the portion that is in contact with the non-adhered portion 26 (portion surrounded by the slit 27). In FIG. 5 in (C), the area to which the adhesive is applied in such a configuration is indicated by hatching with oblique lines. By applying the adhesive only to the portion of the sheet-shaped member 22 that is in contact with the adhered portion 25, the operator can easily peel the portion of the back member 21 surrounded by the slit 27 from the sheet-shaped member 22, and can easily sandwich the detecting unit 30 between the sheet-shaped member 22 and the back member 21.

In this case, when the sheet material is formed, the operator may sequentially perform the steps of providing a masking material 34 in the area that should overlap the non-adhered portion 26 on the back surface of the adhered portion 25 (portion that should be peeled from the sheet-shaped member 22), and applying the adhesive to the back surface of the sheet-shaped member 22. Thus, the adhesive is applied only to the portion of the back surface of the sheet-shaped member 22 that is in contact with the adhered portion 25. Thereafter, the operator may adhere the back member 21 to the sheet-shaped member 22 and then remove the masking material 34. Alternatively, the back member 21 may be adhered to the back surface of the sheet-shaped member 22 after the adhesive is applied only to the surface of the adhered portion 25 of the back member 21. At this time, the non-adhered portion 26 of the back member 21 may be masked and then applied with the adhesive.

Next, the effect of the seat 1 according to the present embodiment will be described.

As shown in FIG. 4 in (B), only the sheet-shaped member 22 is provided between the detecting unit 30 and the seated person. Accordingly, the detection accuracy of the sensor 23 can be improved compared to when two members, the sheet-shaped member 22 and the back member 21, are provided between the detecting unit 30 and the seated person.

In particular, when the sensor 23 is a capacitance sensor, the capacitance becomes smaller as the distance between the detecting unit 30 and the seated person increases, and the sensor 23 is likely to become unstable. In the above embodiment, the detecting unit 30 is provided on the back side (directly below in the case of the seat cushion 4) of the sheet-shaped member 22 so as to contact the back surface thereof, and therefore the detecting unit 30 can be positioned closer to the seated person by the thickness of the back member 21. Accordingly, it is possible to increase the capacitance between the detecting unit 30 and the seated person, thereby improving the stability of the sensor 23 and reducing noise in the detection signal.

Further, when the sensor 23 detects the electrical potential of the body surface, as the distance between the detecting unit 30 and the seated person increases, the capacitance decreases, and the voltage (electrical potential relative to ground) acquired by the sensor 23 also decreases. In the above embodiment, the detecting unit 30 is provided on the back side (directly below in the case of the seat cushion 4) of the sheet-shaped member 22 so as to contact the back surface thereof, and therefore the capacitance between the detecting unit 30 and the seated person can be increased. Accordingly, it is possible to increase the output voltage of the sensor 23, and the noise in the electrical potential detected by the sensor 23 can be reduced.

By forming the slit 27 in the back member 21 and peeling the portion of the back member 21 surrounded by the slit 27 from the sheet-shaped member 22, the detecting unit 30 can be sandwiched between the sheet-shaped member 22 and the back member 21. Accordingly, the detecting unit 30 can be easily arranged at a position between the sheet-shaped member 22 and the back member 21, where only the sheet-shaped member 22 is provided between the detecting unit 30 and the seated person.

In the present embodiment, the slit 27 is formed in a U-shape when viewed in the front-to-back direction. Accordingly, the operator can easily peel the portion of the back member 21 surrounded by the slit 27 from the sheet-shaped member 22, and can easily arrange the detecting unit 30 between the sheet-shaped member 22 and the back member 21.

### Modified Embodiment of the Seat According to the First Embodiment

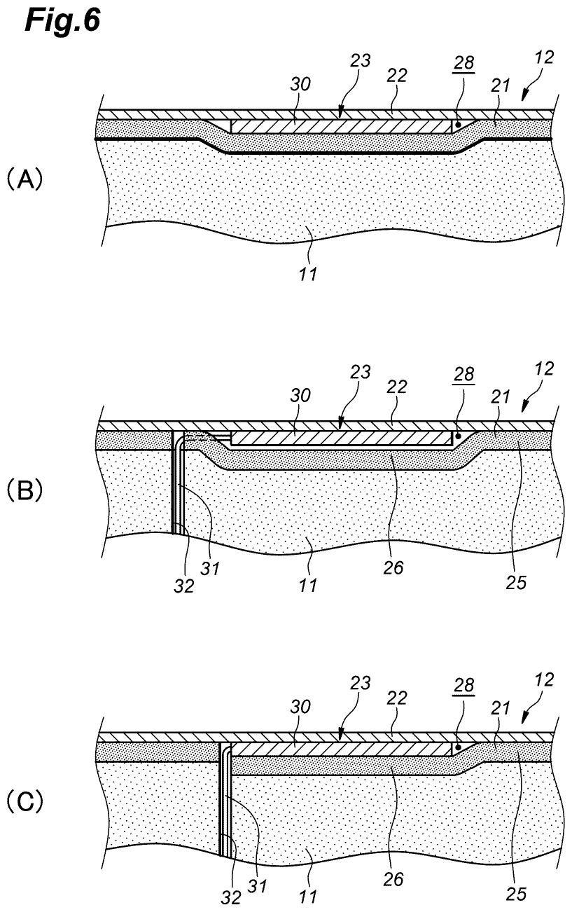

In the above embodiment, the back member 21 is joined to the sheet-shaped member 22, but as shown in FIG. 6 in (A), the back member 21 may be joined to the surface of the pad member 11, and the sensor 23 may be joined to the sheet-shaped member 22. The sheet-shaped member 22 is arranged to cover the back member 21 and the pad member 11, and the ends thereof may be engaged with wires, hooks, or the like provided on the seat frame 40 or the pad member 11.

In the above embodiment, the back member 21 is joined to the back surface of the sensor 23, but as shown in FIG. 6 in (B), the front surface of the back member 21 and the back surface of the sensor 23 may not be joined, and the front surface of the back member 21 and the back surface of the sensor 23 may be space apart in the front-to-back direction.

In FIG. 3, the non-adhered portion 26 is shown to be connected to the adhered portion 25 at one end and joined to the back surface of the skin material 12 at the other end, but as shown in FIG. 6 in (C), the non-adhered portion 26 may be connected to the adhered portion 25 at one end and joined only to the back surface of the sensor 23 joined to the back surface of the skin material 12 at the other end.

### Second Embodiment

The seat 1 according to the second embodiment differs from the first embodiment in the configuration of the skin material 12, but other configurations are the same as those according to the first embodiment, so a description of the other configurations will be omitted. In the second embodiment, the skin material 12 provided on the seat back 5 has a configuration generally similar to that of the skin material 12 provided on the seat back 5.

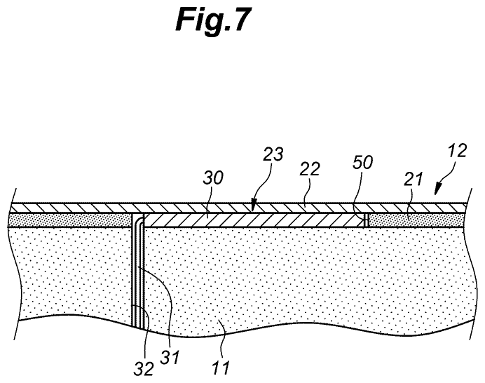

As shown in FIG. 7, the skin material 12 includes the back member 21 that constitutes the pad member 11 side, the sheet-shaped member 22 that constitutes the outer surface side of the seat cushion 4, and the sensor 23 that detects information related to the seated person, as in the first embodiment.

The back member 21 includes an adhered portion 25 joined to the back surface of the skin material 12. The detecting unit 30 of the sensor 23 is joined to the back surface of the skin material 12 at a position that does not overlap the back member 21 in the front-to-back direction. In the present embodiment, the back member 21 is provided with a penetrating hole 50 that penetrates in the front-to-back direction, and the detecting unit 30 is accommodated in the penetrating hole 50.

The detecting unit 30 of the sensor 23 may be arranged in a position that does not overlap the back member 21 in the front-to-back direction, and may be joined to the surface of the pad member 11 instead of (or in addition to) the back surface of the skin material 12.

Next, the effect of the seat 1 configured in this manner will be described.

As shown in FIG. 7, only the sheet-shaped member 22 is provided between the detecting unit 30 and the seated person. Accordingly, the detection accuracy of the sensor 23 can be improved compared to when the two members, the sheet-shaped member 22 and the back member 21, are provided between the detecting unit 30 and the seated person.

### Third Embodiment

The seat 1 according to the third embodiment differs from the first embodiment in the configuration of the sensor 23, but other configurations are the same as those according to the first embodiment, so a description of the other configurations will be omitted.

The sensor 23 according to the third embodiment is the capacitive sensor 23, and is provided with the detecting unit 30 that detects information about the seated person, and the harness 31, as in the first embodiment. The harness 31 is connected at one end to the detecting unit 30 and at the other end to the electronic control unit 33.

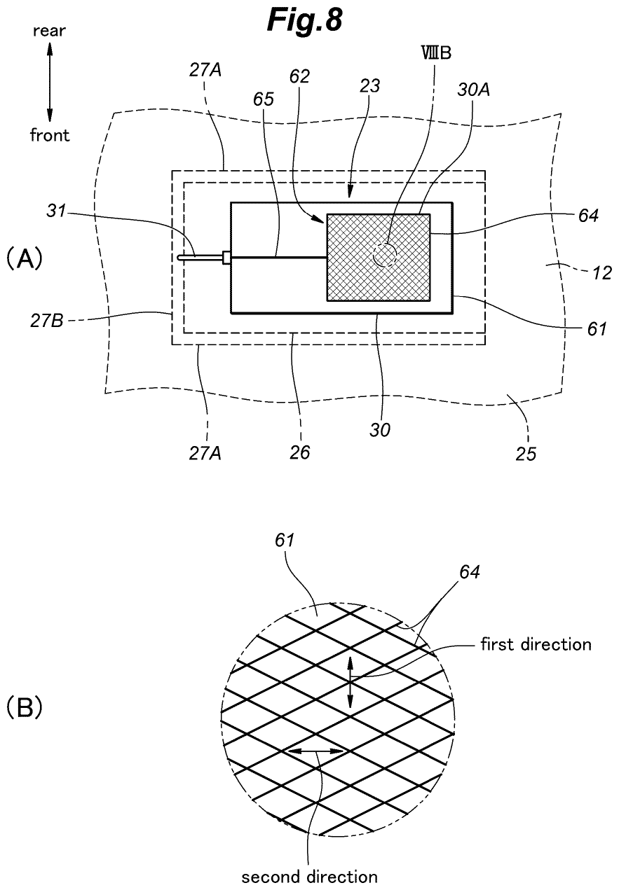

As shown in FIG. 8 in (A), the detecting unit 30 includes a sheet shaped base material 61 that is stretchable in the in-plane direction, and a conductive pattern 62 having conductivity and provided on the surface of the base material 61. The base material 61 is formed from a material having a flexibility similar to that of the back member 21, such as silicone rubber or elastomer. The conductive pattern 62 includes an electrode portion 64 for detecting the capacitance and a lead-out portion 65 for connecting the electrode portion 64 and the harness 31.

The electrode portion 64 constitutes the electrode 30A for detecting contact or proximity of a conductor by detecting changes in capacitance. The electrode portion 64 has a quadrangular shape (rectangular shape) in plan view.

In the present embodiment, the electrode portion 64 is constituted by a mesh electrode formed in a diamond-shaped lattice pattern using thin metal wires. Hereinafter, as shown in FIG. 8 in (B), of the two diagonals of the diamond-shaped patterns included in the mesh electrode, the extension direction of the shorter diagonal is defined as a first direction, and the extension direction of the longer diagonal is defined as a second direction. The first direction and the second direction are perpendicular to each other. Accordingly, the electrode portion 64 is more easily stretched in the first direction than in the second direction. The electrode portion 64 may be formed by applying a paste ink containing a metal filler to the base material 61.

When the support frame 18 extends between the front member 16 and the rear member 17, the detecting unit 30 is arranged between the sheet-shaped member 22 and the back member 21 so that the first direction of the electrode portion 64 is oriented in the front-and-rear direction, and is adhered to at least one of the back surface of the sheet-shaped member 22 and the surface of the back member 21.

Next, the effects of the seat 1 configured in this manner will be described. The detecting unit 30 is arranged between the sheet-shaped member 22 and the back member 21 as in the first embodiment. Accordingly, the detection accuracy of the sensor 23 can be improved compared to when two members, the sheet-shaped member 22 and the back member 21, are provided between the detecting unit 30 and the seated person, as in the first embodiment.

When a load is applied to the seating surface S from the seated person, the pressure receiving member 42 and the support frame 18 bend, and each tends to expand in the extending direction thereof. In the present embodiment, the detecting unit 30 is arranged so that the direction in which the electrode portion 64 is likely to expand (also referred to as the easily expandable direction) coincides with the direction in which the pressure receiving member 42 and the support frame 18 extend (also referred to as the extending direction). Accordingly, even when the pressure receiving member 42 or the support frame 18 bends due to the load from the seated person and expands in the extending direction thereof, the electrode portion 64 can easily follow the expansion.

This concludes the description of the specific embodiments, but the present invention is not limited to the above embodiments or modifications, and can be widely modified and implemented.

In the above embodiment, an example was described in which the skin material 12 and the sensor 23 are provided on the seat back 5 and the seat cushion 4, but the skin material 12 and the sensor 23 may also be provided on the headrest 6 or an armrest on which the seated person places their wrists, elbows, and the like. In this case, as in the first and third embodiments, the detecting unit 30 of the sensor 23 may be configured to be arranged between the sheet-shaped member 22 and the back member 21, and as in the second embodiment, the detecting unit 30 of the sensor 23 may be accommodated in the penetrating hole 50 provided in the back member 21 on the back side of the sheet-shaped member 22.

The skin material 12 and the sensor 23 may also be provided on the interior wall surface of a vehicle interior material (for example, door trim). In this case as well, the detecting unit 30 of the sensor 23 may be arranged between the sheet-shaped member 22 and the back member 21, or the detecting unit 30 of the sensor 23 may be accommodated in the penetrating hole 50 provided in the back member 21 on the back side of the sheet-shaped member 22.

In the third embodiment, the electrode portion 64 is configured to have a rectangular shape in plan view, but may also be configured to have a circular or elliptical shape. The electrode portion 64 is constituted by the mesh electrode, but may be constituted by the mesh electrode formed in a square lattice pattern, or may be constituted by the comb electrodes or the like.

### LIST OF REFERENCE NUMERALS

1: seat
11: pad member
12: skin material
21: back member
22: sheet-shaped member
23: sensor
25: adhered portion
26: non-adhered portion
27: slit
28: accommodating space
30: detecting unit
30A: electrode
31: harness
32: through hole
34: masking material
S: seating surface

1. A vehicle seat comprising:
a pad member;
a sheet-shaped member covering a surface of the pad member;
a back member provided on a back surface side of the sheet-shaped member; and
a sensor including a detecting unit configured to acquire information related to a seated person, wherein
at least a portion of the detecting unit is arranged between the sheet-shaped member and the back member.

2. The vehicle seat according to claim 1, wherein the sheet-shaped member and the back member constitute a skin material, and
the back member includes an adhered portion adhered to the sheet-shaped member and a non-adhered portion that cooperates with the sheet-shaped member to define an accommodating space for accommodating the detecting unit.

3. The vehicle seat according to claim 2, wherein the back member is formed in a sheet shape extending along the surface of the pad member and provided with a slit extending along the non-adhered portion.

4. The vehicle seat according to claim 2, wherein the back member is provided with a slit connected to the accommodating space.

5. The vehicle seat according to claim 1, wherein the back member is more flexible than the sheet-shaped member.

6. The vehicle seat according to claim 1, wherein the detecting unit is provided with an electrode for detecting the seated person based on a change in capacitance.

7. The vehicle seat according to claim 1, wherein the detecting unit is provided with an electrode that is electrostatically coupled to a body of the seated person to detect an electrical potential of a body surface of the seated person so as to acquire at least one of heart rate, heartbeat interval, and an electrocardiogram of the seated person.

8. The vehicle seat according to claim 1, wherein the sensor includes a harness connected to the detecting unit, and
the pad member is provided with a through hole through which the harness passes.

9. A manufacturing method of a vehicle seat, the vehicle seat comprising:
a pad member;
a sheet-shaped member covering a surface of the pad member;
a back member provided on a back surface side of the sheet-shaped member, and
a sensor including a detecting unit configured to acquire information related to a seated person, and the method including steps of:
peeling at least a portion of the back member from the sheet-shaped member; and
sandwiching the detecting unit between the sheet-shaped member and the back member peeled from the sheet-shaped member.

10. The manufacturing method of the vehicle seat according to claim 9, wherein the back member is provided with a slit extending along a portion to be peeled.

11. The manufacturing method of the vehicle seat according to claim 9, the method including steps of:
providing a masking material on a back surface of the sheet-shaped member in a portion corresponding to the back member to be peeled; and
applying adhesive to the back surface of the sheet-shaped member.
